(19) United States
(12) Patent Application Publication
(10) Pub. No.: US 2009/0146391 A1
(43) Pub. Date: Jun. 11, 2009

(54) Folding Bicycle Constructed from Plate Frame Elements

(76) Inventor: Michael T. Sutherland, Calgary (CA)

Correspondence Address: YOUNG & BASILE, P.C., 3001 WEST BIG BEAVER ROAD, SUITE 624, TROY, MI, 48084, US

(21) Appl. No.: 12/277,005

(22) Filed: Nov. 24, 2008

Related U.S. Application Data
(63) Continuation of application No. 10/524,166, filed on Jul. 29, 2005, now abandoned.
(60) Provisional application No. 60/401,334, filed on Aug. 7, 2002.

(51) Int. Cl. B62K 15/00; B62K 3/02

(52) U.S. Cl. 280/287

(57) ABSTRACT

A bicycle frame design using plate frame structural elements for a high performance, full suspension bicycle having the ability to fold up in a package of compact size is provided. The main frame is formed by opposed plate frame elements (1, 2), patterned in the ergonomic dimensions and component arrangements therefrom used for contemporary mountain bikes. The patterned plate frame elements (1, 2) are cut from plate stock in a way that locates and mounts the operative elements in positions required for bike function. Such plate frame structure is of modular, lightweight, and weldless construction. A mechanically simple, lightweight rear shock absorbing system (7, 8, 9) is incorporated. The design routes cables in an internal arrangement, separating them from rider or other attached components or accessories on the inboard side of the plate frame structure. Overall geometry and dimensions of the configuration are adjustable to provide a universal fit for riders of various sizes. The opposed plate frame elements can be separate plates structures, or can be formed by folding a single blank having therein both opposed plate frame elements.

### FIELD OF THE INVENTION

The present invention relates generally to bicycle frames and more specifically it relates to a folding bicycle constructed from plate structural elements for a high performance, full suspension bicycle having the ability to fold up in a package of compact size.

### BACKGROUND OF THE INVENTION

It can be appreciated that bicycle frames have been in use for years. Typically, bicycle frames are comprised of a tubular framework, with structural sections terminated at welded or brazed lug joints. Construction of bicycles having tubular framework requires the use of specialized jigs, alignment fixtures, a variety of cutting tools, and welding equipment for the complete assembly of such structures. Such manufacturing procedures are costly, time consuming, and prone to error.

Functionally, the main problem with conventional bicycle frames arises from the rigid tubular framework generally favored by constructors in the industry. Such frames are usually unable to fold into a configuration of reduced size for more convenient transport and storage. Another problem with conventional bicycle frames resides in the tubular construction itself, which is not the most structurally efficient means of carrying a load intended for said frame. Still another problem with conventional bicycle frames are permanency of traditional and contemporary tubular construction, which cannot be changed or upgraded by the rider to meet changing requirements or tastes. In addition, contemporary rear shock absorption systems on such tube frame bicycles tend to be mechanically complex, utilizing a number of bar linkages and pivots that form a significant portion of the bicycle's weight.

While these devices may be suitable for the particular purpose to which they address, they are not as suitable for a high performance, full suspension bicycle having the ability to fold up in a package of compact size.

### SUMMARY OF THE INVENTION

It is an object of an aspect of this invention to provide a folding bicycle constructed from plate structural elements that substantially departs from the conventional concepts and designs of the prior art, and in so doing provides an apparatus primarily developed for the purpose of a high performance, light weight, full suspension bicycle having the ability to fold up in a package of compact size. Such method of construction using plateframe structures offers design flexibility for creating variants of lighter and stronger structure than tubular frame bicycles. In addition, the structural plates forming this new configuration make use of automatic manufacturing techniques such as modern computer numerically Controlled (CNC) production equipment, that reduce cost and manufacturing time, and increase versatility in relation to standard tubular frame bicycles. Said plateframe structures can be arranged in a virtually unlimited range of geometries to conform with operational requirements as defined by different market segments. In addition, this method results in a bike structure of greatly reduced cost, increased user convenience, and improved operational performance compared to the most advanced tubular bike frames currently available.

An object of an aspect of the present invention is to provide a folding bicycle constructed from plate structural elements that will overcome the shortcomings of the prior art devices.

Another object of an aspect of the present invention is to provide a folding bicycle constructed from plate structural elements for a high performance, full suspension bicycle having the ability to fold up in a package of compact size. The main frame is formed by two plate frame elements, patterned in the ergonomic dimensions and component arrangements therefrom used for contemporary mountain bikes. The patterned plate frame elements are cut from plate stock in a way that locates and mounts the operative elements in positions required for bike function. Such plate frame structure is of modular, lightweight, and weldless construction that can be assembled or disassembled with basic tools readily available to the consumer market. As an added benefit a mechanically simple, lightweight rear shock absorbing system is incorporated. The design also routes cables in an internal arrangement, separating them from rider or other attached components or accessories on the inboard side of the plateframe structure. Overall geometry and dimensions of this configuration can be altered to provide a fit for riders of various sizes. The structure makes use of a convex recessed main beam, as opposed to the topmost horizontal tubular type found in contemporary bicycles that occasionally present a safety hazard to the rider. Furthermore, the plateframe structure provides planar attachment surfaces for accessories that could not otherwise be fixed conveniently to a bicycle of traditional tubular design. The frame geometry can be formed in a variety of configurations giving a range of new appearances, functional enhancements, and ornamental details not possible with traditional tubular construction. Such method of construction using said plateframe structures offers design flexibility for creating variants of lighter and stronger structure than tubular frame bicycles with reduced manufacturing time and cost.

Another object of an aspect of the present invention is to provide a folding bicycle constructed from plate structural elements that is of lightweight construction and readily collapsible for convenient storage in an area of limited space, for example the trunk of an automobile or a household closet.

Another object of an aspect of the present invention is to provide a folding bicycle constructed from plate structural elements that meets or exceeds weight and performance specifications of contemporary mountain bikes at greatly reduced cost.

Another object of an aspect of the present invention is to provide a folding bicycle constructed from plate structural elements having an integrated suspension capability equal to or better than other competitive mountain bikes currently available for consumer purchase using a simpler, lighter, and more reliable configuration.

Another object of an aspect of the present invention is to provide a folding bicycle constructed from plate structural elements that can be fitted by the rider to function with other compatible or formerly incompatible components; for example, certain structural items particular to a mountain bike can be substituted with road bike running gear.

Another object of an aspect of the present invention is to provide a folding bicycle constructed from plate structural elements that provides a number of attachment points for extra storage compartments or cases.

Another object of an aspect of the present invention is to provide a folding bicycle constructed from plate structural elements that fit a variety of riders with a minimum level of adjustment to plateframe design as required.

Another object of an aspect of the present invention is to provide a folding bicycle constructed from plate structural elements that remove brake and derailleur cables from the exterior framework, where they can interfere with the rider or other frame mounted components.

Other objects and advantages of an aspect of the present invention will become obvious to the reader and it is intended that these objects and advantages are within the scope of the present invention.

According to an aspect of the present invention, there is provided a bicycle frame comprising:

a central load bearing assembly comprising two spaced-apart frame elements maintained in spaced-apart relationship by a plurality of spacers;

a swingarm assembly having first and second ends, said first end being pivotably mounted on said central load bearing assembly at a first attachment point, said second end of said swingarm assembly having a rear wheel releasably secured thereon;

a headset mounted on said central load bearing assembly for supporting a steering and front fork assembly, said front fork assembly having a front wheel releasably mounted thereon; and

a crank bracket mounted between said two spaced-apart frame elements of said central load bearing assembly, said crank bracket being located offset from said first attachment point of said swingarm assembly, said crank bracket supporting a crank assembly.

According to another aspect of the present invention, there is provided a method of forming a central load bearing assembly which has spaced apart frame elements, the frame elements providing for a first attachment point for a swingarm assembly, an attachment point for a headset, an attachment point for a tail block and an attachment point for a crank bracket, the method comprising folding a blank having two opposed frame elements interconnected by a web where the blank is folded along the web to provide spaced-apart opposed frame elements interconnected by an integral spine formed by said web.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a side view of the present invention.

FIG. 2 is a top view of the present invention.

FIG. 3 is a perspective view of the present invention.

FIG. 4 is a detail view of the pivoting headset arrangement.

FIG. 5 is a detail view of the lower bracket within the plateframe assembly.

FIG. 6 is a detail view of the swingarm ladder assembly.

FIG. 7 is an exploded view of the present invention showing all of the frame components.

FIG. 8 is a detail view of the rear shock connection.

FIG. 9 is a detail view of the front derailleur.

FIG. 10 is an elevation view of the present invention in a folded configuration.

FIG. 11 is an elevation view of the left plate frame.

FIG. 12 is a section view of the plateframe assembly in folded configuration.

FIG. 13 is a perspective view of the pivoting headset.

FIG. 14 is a detail view of the pivoting headset rotated to folded position in the plateframe assembly.

FIG. 15 is a detail view of the swingarm ladder assembly adjusted to folded position in the plateframe assembly.

FIG. 16 is a perspective view of the frame in folded configuration.

FIG. 17 is a perspective view of the front forks.

FIG. 18 is a perspective view of the tail block.

FIG. 19 is perspective view of an alternate embodiment of the present invention.

FIG. 20 is an elevation view of the plate frame patterns prior to folding according to the alternate embodiment of FIG. 19.

FIG. 21 is an end view of a folded frame according to the alternate embodiment of FIG. 19.

FIG. 22 is a perspective view of a unitary swingarm assembly . . . .

### DETAILED DESCRIPTION OF THE INVENTION

An aspect of the present invention provides a new folding bicycle constructed from plate structural element construction wherein the same can be utilized for a high performance, full suspension bicycle having the ability to fold up in a package of compact size. The main frame is formed by opposed plate frame elements, patterned in the ergonomic dimensions and component arrangements therefrom used for contemporary mountain bikes. The patterned plate frame elements are cut from plate stock in a way that locates and mounts the operative elements in positions required for bike function. Such plate frame structure is of modular, lightweight, and weldless construction that can be assembled or disassembled with basic tools readily available to the consumer market. As an added benefit a mechanically simple, lightweight rear shock absorbing system is incorporated. The design also routes cables in an internal arrangement, separating them from rider or other attached components or accessories on the inboard side of the plateframe structure, Overall geometry and dimensions of this configuration can be altered to provide a fit for riders of various sizes. In one embodiment, the structure makes use of a convex recessed main beam, as opposed to the topmost horizontal tubular type found in contemporary bicycles that occasionally present a safety hazard to the rider. Furthermore, the plateframe structure provides planar attachment surfaces for accessories that could not otherwise be fixed conveniently to a bicycle of traditional tubular design. The structural plate frame elements forming this new configuration can be designed in a number of ways, giving a variety of new appearances, functional enhancements and ornamental details not possible before. The plateframe structures can also be arranged to form functional versions that are lighter, stronger and less costly than other comparable machines in the market. While the plateframe structures are generally planar, they may also be stamped to provide offset mounting points for operational elements or accessories.

The general purpose of an aspect of the present invention, which will be described subsequently in greater detail, is to provide a new folding bicycle constructed from plate frame elements that has many of the advantages of the bicycle frames mentioned heretofore and many novel features that result in a new folding bicycle constructed from plate frame elements which is not anticipated, rendered obvious, suggested, or even implied by any of the prior art bicycle frames, either alone or in any combination thereof.

To attain this, an aspect of the present invention generally comprises a twin plateframe arrangement, fastened together at a plurality of fastener locations. The main frame is formed by two plate frame elements, patterned in the ergonomic dimensions and component arrangements therefrom used for contemporary mountain bikes. The patterned plate frame elements are cut from plate stock in a way that locates and mounts the operative elements in positions required for bike function. Joining the plate frame elements are a series of threaded fasteners, in combination with co-axial standoffs that keep the plate frame elements separated by a prescribed distance. The plate frame elements so joined comprise a central load bearing assembly to which a number of functional elements or accessories are mounted or attached. A plurality of drilled holes in one plate, with aligned tapped holes in the other are provided for fastener assemblies spanning across the plate array separated distance. A pivoting headset captured between the two plate frame elements is provided for rotating and stowing the front forks in the frame envelope. The pivoting headset is a machined block with provision for mounting to and rotating within the twin plate frame structure. A master bore drilled along the headset longitudinal axis captures and supports the front fork upright shaft. Drill holes in the pivoting headset through the transverse axis are used in conjunction with threaded fasteners for rigid attachment to the plate frame elements. The drill holes are arranged with respect to a pivot boss bearing on the pivot headset so that two fixed orientations relative to the frame are possible. One position gives a riding operational configuration, the other a folded stowed configuration. The tail block is a structural item used to capture the seat post and one end of the shock absorber. A master bore drilled along the tail block longitudinal axis captures and fixes the seat post. A pin eye bore, drilled across the clevis at the rear of the tail block, provide a mounting point for the shock absorber pin. Two counterbored and threaded holes directly behind the master seat post bore bridge a longitudinal slot, and provide a means for two socket head cap screws to tighten the tail block around the seat post. Two pairs of threaded blind holes at the tail block location, four per side, align with mating through-holes in both plate frames. A threaded fastener passes through each plate frame through-hole and fastens into the mating threads in the tail block blind holes. Integrated into the design is a pivotable swingarm assembly, attached at plateframe and shock absorber pinned connection points. In one embodiment, an integrated swingarm assembly is composed of four plateframe structures joined as two parallel running rails in a ladder configuration. The ladder is pinned at two locations; one for the shock absorber and one at the twin plate frame swingarm bearing. Each running rail is made from one swingarm and one rocker arm. The swingarms are left and right handed, and mount equipment specific to that side of the bike. A disk brake assembly on the left requires a brake swingarm, and the rear sprocket derailleur on the right requires a derailleur swingarm. Rocker arms in this assembly are mirror images, having the same profile for both sides. A series of threaded fasteners, in conjunction with co-axial stand offs, are used to join the swingarms and rocker arms together. The co-axial standoffs are used to step the swingarms relative to the rocker arms so that the ladder rails are properly spaced at the rear wheel axle. Two swingarm links, placed at either side of the shock absorber, fasten the rails together at the shock absorber pivot location. The swingarm links provide a means of force transmission from the rails to the shock absorber through a common pin, coaxially mounted to the swingarm links. Force transmission travels from the common pin through the shock absorber, where it is attenuated by some preset amount, to the tail block shock pin. The ladder pivots about a swingarm bearing mounted to the aft section of the twin plateframe structure. A master pin through the twin plateframe and swingarm bearing hold the two assemblies together.

There has thus been outlined, rather broadly, features of an aspect of the invention in order that the detailed description thereof may be better understood, and in order that the present contribution to the art may be better appreciated. There are additional features of the invention that will be described hereinafter.

In this respect, before explaining at least one embodiment of an aspect of the invention in detail. It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

To the accomplishment of the above and related objects, this Invention may be embodied in the form illustrated in the accompanying drawings, attention being called to the fact, however, that the drawings are illustrative only, and that changes may be made in the specific construction illustrated.

Turning now descriptively to the drawings, in which similar reference characters denote similar elements throughout the several views, the attached figures illustrate a folding bicycle constructed from plate frame elements.

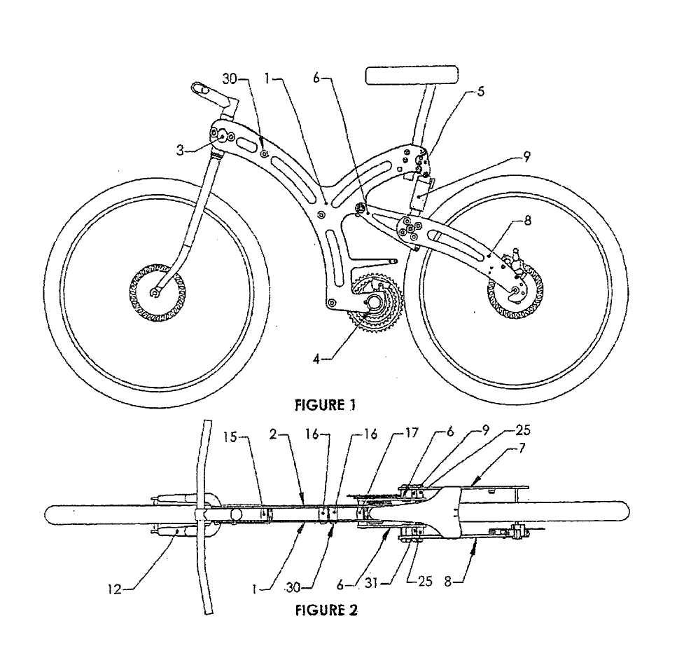

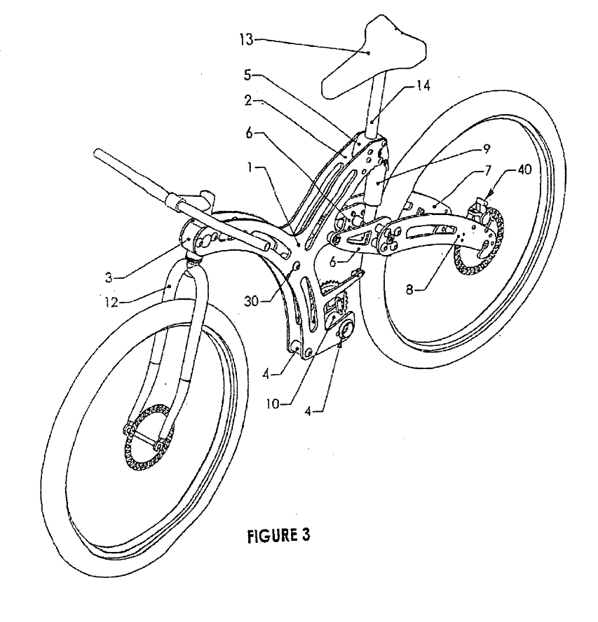

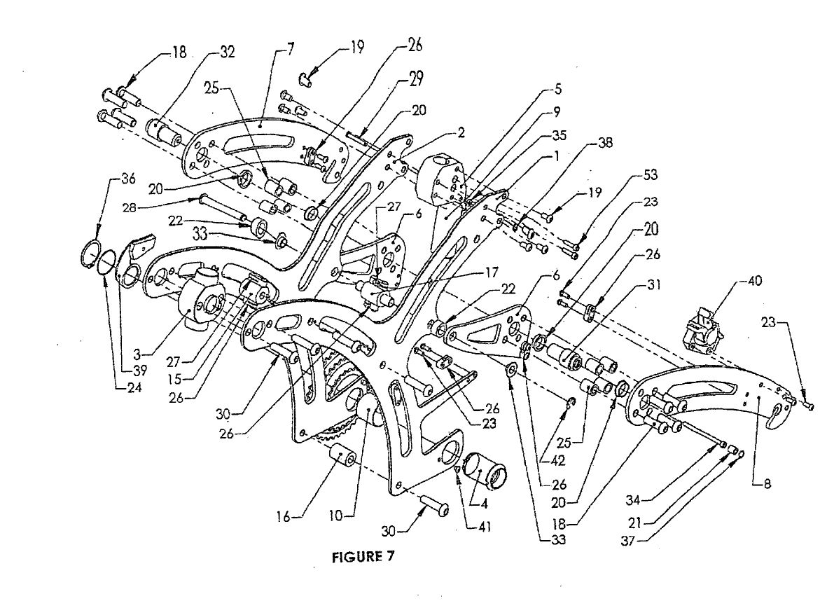

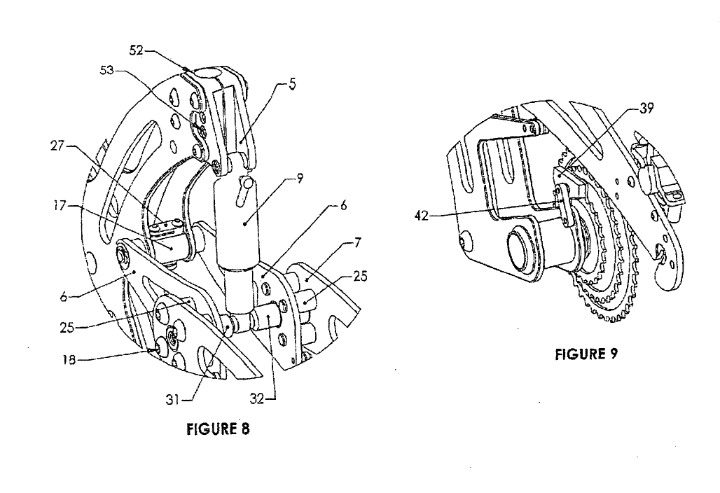

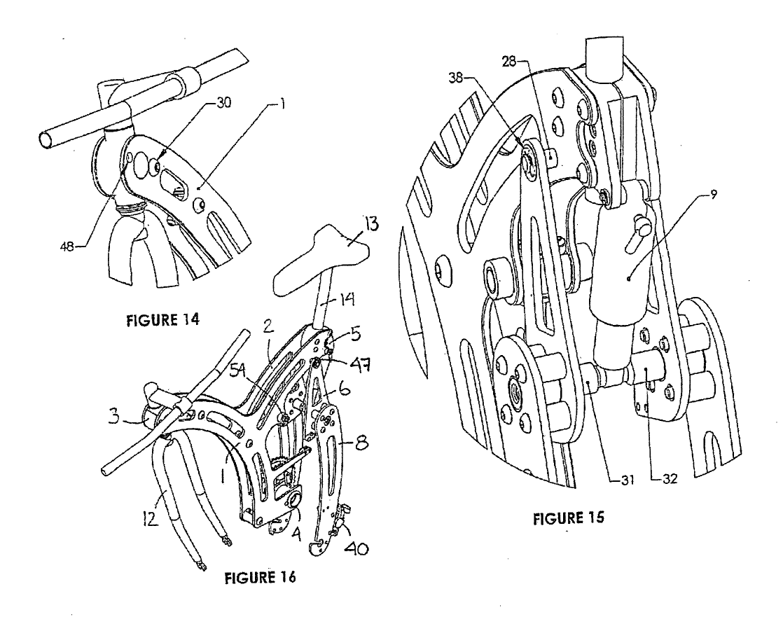

The central load bearing assembly is formed by opposed plate frame elements, patterned in the ergonomic dimensions and component arrangements therefrom used for contemporary mountain bikes. The patterned plate frame elements are cut from plate stock in a way that locates and mounts operative elements in positions required for bike function. Joining the plate frame elements are a series of threaded fasteners, in combination with co-axial standoffs that keep the plate frame elements separated by a prescribed distance. The plate frame elements so joined comprise central load bearing assembly to which a number of operative elements or accessories are attached. A plurality of drilled holes in one plate, with aligned tapped holes in the other are provided for fastener assemblies spanning across the plate separated distance. As shown in FIG. 1, the plate frame design comprises a number of elements forming a rigid assembly. Plate frame element 1 is joined with a plurality of fasteners 30 to plate frame element 2 as shown in FIGS. 2, 3, and 7. Plate frame elements 1 and 2 can be made from a variety of materials such as metal, fiberglass or some other types of composites well known to the hiking industry. Preferably plate frame elements 1 and 2, comprising the major structural portion of the bike frame, are made from aluminum or titanium plate of appropriate thickness. It can be appreciated by one skilled in the art that an optimum thickness in commercially available quantifies can be determined according to an engineering analysis of the frame subjected to expected riding forces. In this case, material thickness falls in the 3/16″ to ⅜″ range. Plate thickness is also dependent on frame geometry, and the design shown in FIGS. 1, 2, 3 and 7 give one of a number of possible variations that serve adequately for carrying mechanical loads during riding. Although a number of configurations are possible, the general specification shown in the attached figures serve to show how such structure is workable in practice. Plate frame elements 1 and 2 are joined by fasteners 30 at a number of locations, and by operational elements pivoting headset 3, tail block 5, and lower bracket 4 as are all seen in FIG. 1. The assembly is also held together by pin 28 and circular clip 42 shown in FIGS. 6 and 7, and additionally forms a pivot point for the rear suspension system. Other components shown in FIG. 7 forming part of the pivot point, that is 22, 33, and 17, do not hold plate frame elements 1 and 2 together but provide low friction load carrying cylindrical surfaces for smooth operation of the swingarm assembly. Plate 2, as can be appreciated by one skilled in the art, includes tapped holes at all fastener 30 locations, and threadably engages fasteners 30 for attachment to plate 1. As will also be appreciated, tapped holes in plate 2 may be replaced with standard holes, and a threaded nut used to engage the exposed threaded portions of fasteners 30. Fasteners 30 in this case are longer to provide sufficient threaded length to engage with an external nut. Other fasteners, adhesives, weldments, and bearing type structures are known to replace fasteners 30 inserted in plate 1 through-holes and co-axial threaded holes in plate 2, and will be considered to be incorporated as another aspect of the invention herein. Furthermore the number of fasteners threaded, adhesive or otherwise is not fixed, as a designer may opt for more or less as is practicable. Additional plate enjoinment comes from the cylindrical lower bracket 4 in FIG. 7, which engages with circular clip 36 to capture the lower portion of the frame in corresponding apertures. To prevent the lower bracket 4 from rotating within the aperture of the frame elements, threaded pin 41 is provided. Bracket spacer 10 is used in conjunction with lower bracket 4, washer 24 and circular clip 36 to provide a preset distance between the two plate frame elements. The lower bracket assembly also serves to support front derailleur 39 which is locked in place using bracket 42. Frame spacers 15, 16, and 17 in FIG. 7 are also used to provide spacing between the plate frames, and have a width equal to bracket spacer 10, pivoting headset 3, and tail block 5. An additional function of frame spacers 15 and 17 is to serve as attachment points for cable routing fixtures 26 and 27. Additional cable routing fixtures 26 are provided for direct attachment to the frame element using fasteners 23. Tail block 5 is rigidly captured between both plate frame elements in FIG. 7 using fasteners 19 passing through full depth holes drilled in the plate frame elements and fastening into matching threaded holes in the tail block. Both plate frame elements 1 and 2 have mirrored bolt patterns at the tail block 5 position. Pivoting headset 3 is captured by fasteners 30, and pivot boss 46 in FIG. 13. Pivot boss 46 integrates rotatably into hole 50 as shown in FIG. 11. It can be appreciated that plate frame elements 1 and 2 have a hole 50 capturing pivot boss 46 on either side of pivoting headset 3, allowing it to rotate freely when clear of fasteners 30 at the pivot headset through-holes 48 and 49. Through holes 48 and 49 are shown in FIG. 11. Plate frame elements 1 and 2 preferably include a number of elongated slots and drill holes, and although not required for frame function are useful for reduction of overall frame weight. As a practitioner in the art will appreciate, bending forces are carried mainly around the frame periphery, and thus said material within the elongated slots and drill holes may be removed as engineering analysis allows. Preferably, the twin plateframe has a geometry and configuration as shown in 1, 2, 3 and 7, however, the major plateframe structures can be designed with almost limitless elevation profiles. A number of geometries are possible with this type of plate frame construction observing that industry developed distances and angles are approximated between pivoting headset 3, lower bracket 4, and tail block 5. The generally planar surfaces provided by the design can serve as a mounting face for a wide range of fixtures and ornamentation not shown in the figures. Alternatively, it can be appreciated that the plate frame elements may be stamped to provide offsets for ornamental purposes, for mounting operational elements, or for providing other functional enhancements. For example, it is possible to machine a carrying handle or other useful feature into the structure, or modify it in certain areas to affix a variety of bike accessories and other paraphernalia. The plate frame elements may be designed with any combination of curves and straights as is shown, using a limitless mixture thereof. It is possible to construct a similar assembly using one plate instead of two, or indeed any number of plate frame elements desired as is practicable for a working frame. The methods of attachment between plate frame elements are not limited to threaded fasteners. A number of other securing combinations, for example weldments, glue or other viable adhesive, can be used to join the plate frame elements for an operable configuration. In such case the frame may become a permanent fixture and will be recognized as limited to repair and replacement compared to using removable fasteners.

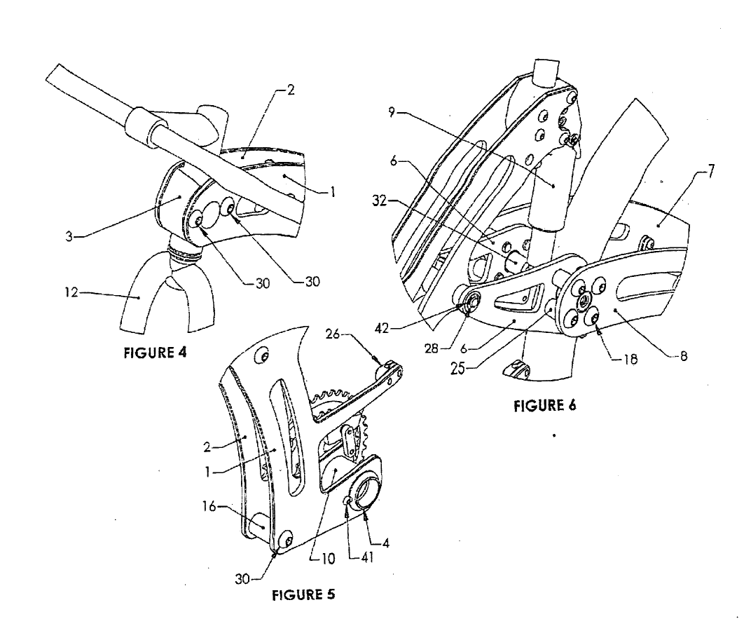

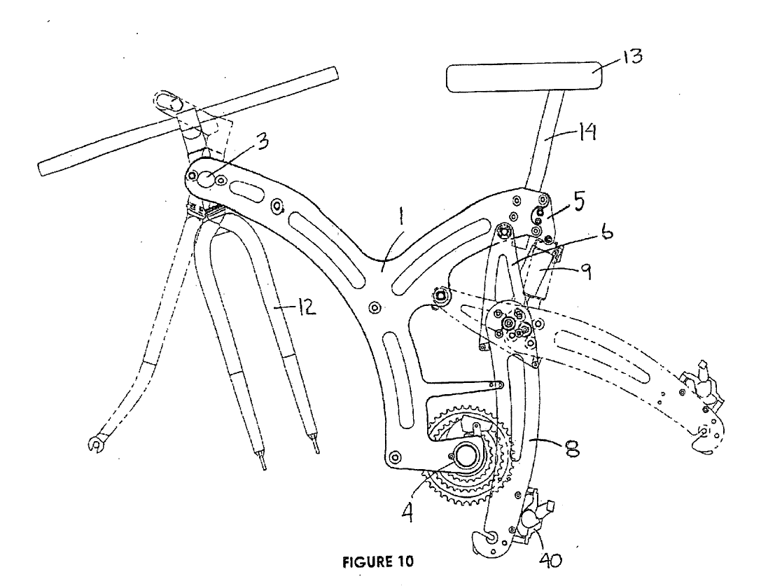

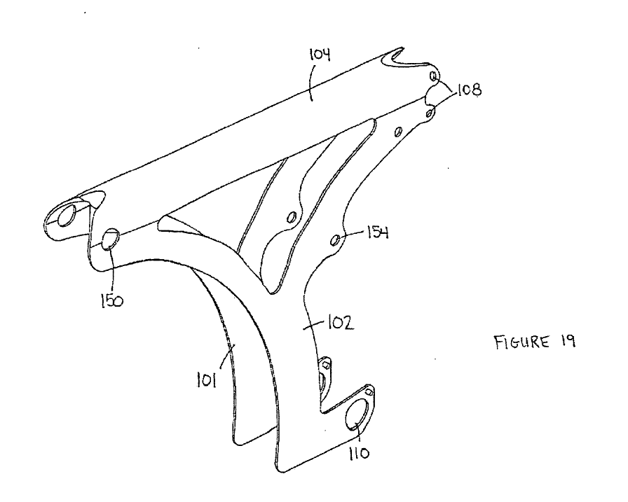

The pivoting headset is a machined monobloc with provision for mounting to and rotating within the plane of the central load bearing assembly. A master bore drilled along the headset longitudinal axis captures and supports the front fork upright shaft. Drill holes in the pivoting headset through the transverse, or thickness, axis are used in conjunction with threaded fasteners for rigid attachment to the plate frames. The drill holes are arranged with respect to the pivot boss bearing so that two fixed orientations relative to the frame are possible. One position gives a riding operational configuration, the other a folded stowed configuration. The pivoting headset attachment comprises a machined block as illustrated in FIGS. 1, 3, 4, 7 and 13. This component is adjustably fixed within the plateframe structure, and mounts a rotatable front fork assembly extending therefrom. FIGS. 1, 3, 4 and 7 demonstrates said pivoting headset as incorporated into the central load bearing assembly. One function of pivoting headset 3 is to provide a means for switching between riding or operational configuration to a stowed configuration for the said front forks. Front forks 12, as demonstrated by assorted view angles in FIGS. 1, 3, 4, 10, 12, 14 and 16, rotates within the pivoting headset freely as is required for a bike steering function or stowed configuration. A master bore 51 in FIG. 13, drilled longitudinally through the pivoting headset, mates with bearing surface 57 attached to the topmost portion of said forks 12. Bearing surface 57 is illustrated in FIG. 17. The pivoting headset is machined from an aluminum block in this embodiment, to a thickness matching other spanning components in the plateframe assembly. For example, pivoting headset thickness is set equal to frame spacers 15, 16, and 17 in FIG. 7. Two threaded fasteners 30 in exploded FIG. 7 capture the pivoting headset within the plate frame structure, securing it for operational or stowed usage. Removal of the threaded fasteners 30 permits the headset to rotate freely between the plate frame elements by means of pivot boss 46 in FIG. 13, which engages with hole 50 in FIG. 11. Hole 50 is a feature incorporated into plate frame elements 1 and 2, both of which capture pivot boss 46 on either side of the pivoting headset. Adjusting the pivoting headset for a stowed configuration requires first the removal of fasteners 30 and rotating the headset to a position where through-hole 45 lines up with plate frame hole 48, as displayed in FIGS. 13 and 11 respectively. Fastener 30 is then re-installed in said aligned holes 45 and 48, securing the pivoting headset in the stowed position. The stowed configuration of this aspect of the invention can be fully viewed in FIGS. 10, 12, 14 and 16. While only three bolt holes 43, 44 and 45 are shown for securing operating and stowed configurations, a designer may opt for more or less as practically required. Preferably, the pivoting headset has a configuration as shown in FIGS. 7 and 13, however a number of other profiles and attachment options are possible. For example, it is possible to omit pivot boss 46 and use holes 43, 44, and 45 or some combination thereof to carry out pivoting headset functions. The said pivoting headset may be made from a variety of materials and of different thicknesses, as is practicable to accommodate the front forks. For example, this component may be constructed of various materials such as metal, fiberglass, or other viable composite. The overall geometric configuration shown in the present embodiment is not fixed, for example a number of different shapes may be used as is the designer's prerogative for decorative of other functions. One of the main functions of the headset, that is to provide a means of switching between an operational and stowed configuration, may be limited by design to riding configuration only with modification to or omission of pivot boss 46. Furthermore, fastener holes 44, 45, and 36 can be eliminated along with fasteners 30 in favor of some other bearing structure or adhesive to achieve a single purpose riding configuration.

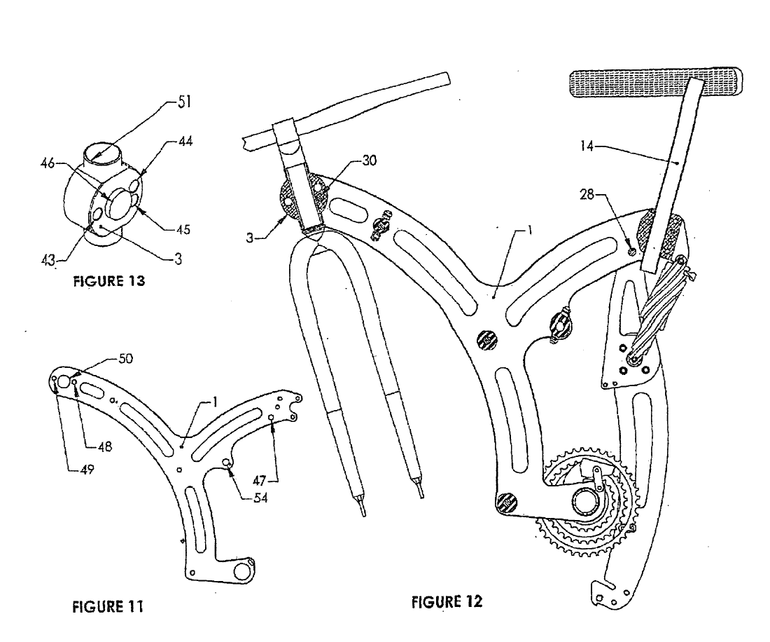

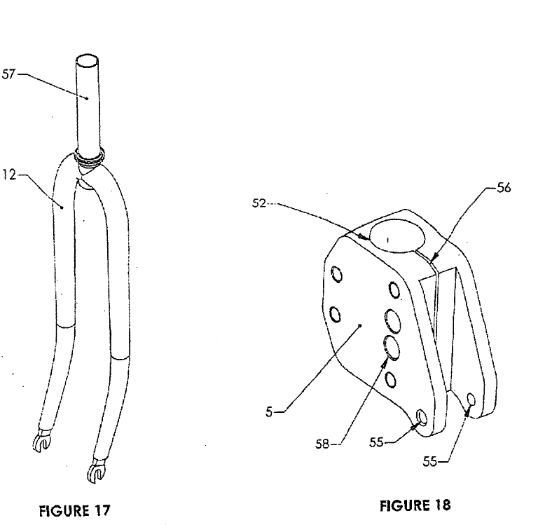

The tail block is a structural item used to capture the seat post and one end of the shock absorber. A master bore drilled along the tail block longitudinal axis captures and fixes the seat post. A pin eye bore, drilled, across the clevis at the rear of the tall block, provide a mounting point for the shock absorber pin. Two counterbored and threaded holes directly behind the master seat post bore bridge a longitudinal slot, and provide a means for two socket head cap screws to tighten the tail block around the seat post. Two pairs of threaded blind holes, four per side, align with mating through-holes in both plate frames. A threaded fastener passes through each plate frame through-hole and fastens into the mating threads in the tail block blind holes. The tail block component comprises a machined body 5 as shown in FIGS. 1,3,7,8 and 18. Referring to FIG. 18, such component has master bore 52 drilled longitudinally through its height as required to engage seat post 14 in a fixed position as illustrated in FIG. 12. Seat post 14, supporting seat 13, is clamped rigidly to tail block 5 by means of slot 56 and cross-drilled holes 58, both of FIG. 18. Cross drilled holes 58 are used with socket head cap screws 53 to force slot 56 closed, thereby tightening the tail block around seat post 14. From FIG. 18, it is apparent that slot 56 runs through the height of tail block 5 and from master bore 52 rearward. A person of ordinary skill would see that the removal of material embodied as slot 56 effectively turns the tail block into a two pronged clamp, which can be tightened around seat post 14 with socket head cap screws 53 as illustrated in FIG. 7. Threaded holes 58 in FIG. 18 are provided for socket head cap screws 53 behind master bore 52, as this is the best position for clamp function. It is pointed out that any number of socket head cap screws 53 as is practicable may be used. In addition, it is recognized that socket head cap screws 53 may be replaced by other types of load bearing fasteners. The tail block, in addition to frame spacer and seat post support also serves as a load point for the swingarm ladder system attached pivotally to the central load bearing assembly. One end of the shock absorber 9 is held by pin 29, inserted into bore 55 at the clevis portion of the tail block. Bore 55 is shown in FIG. 18. Circular clip 38 holds pin 29 and washer 35 in place; both components can be seen in FIGS. 7 and 15. From FIG. 15, it is clear that the clevis feature machined into the tail block captures the shock absorber, with both ears of the clevis sharing co-axial bore 55. Mechanical forces are transmitted through pin 29 from the shock absorber into the tail block, which are then passed through to plate frame elements 1 and 2 by means of fasteners 19. It can be seen that a plurality of fasteners 19 engage through a hole pattern at the tail block location of plate frame elements 1 and 2, and threadably mate with co-axial tapped holes on both sides of the tail block. That fasteners 19 are threaded in this embodiment does not limit the method of attachment to this type of device. The tail block can be fastened to plate frames 1 and 2 with threaded or some other type of load bearing fastener. Attachment of the tail block to the frame members using adhesives is also possible. Although the current embodiment includes an attachment point for a shock absorber 9, it is not necessary that one be included. It is possible to design attachment points for the shock absorber at other locations in the frame, leaving the tail block to function as a seat post support and a frame securement. Threaded fasteners 53, used to clamp the seat post in place, may also be replaced with other viable tightening devices. Furthermore, the tail block can incorporate other means of fastening the seat post in place. For example, two collars tightened around the seat post 14, positioned above and below the tail block respectively, can be used to axially fix it in place. Such collars can be used in place of slot 56 and fasteners 53. Fasteners 19 can also be re-arranged in a number of viable ways to fix the tail block in place with respect to the plate frame structure.

The swingarm ladder assembly is composed of four plateframe structures joined as two parallel running rails in a ladder configuration. The ladder is pinned at two locations; one for the shock absorber and one at the central load bearing assembly swingarm bearing. Each running rail is made from one swingarm and one rocker arm. The swingarms are left and right handed, and mount equipment specific to that side of the bike. A disk brake assembly 40 on the left requires a brake swingarm 8, and the rear sprocket derailleur on the right requires a derailleur swingarm 7. Both swingarms are illustrated in FIG. 7. Rocker arms 6, also shown in FIG. 7, are mirror images having the same profile for both sides in the illustrated embodiment, but are not limited to this geometric configuration. A series of threaded fasteners 18, in conjunction with co-axial stand offs 25, are used to join swingarms 7 and 8 to rocker arms 6 respectively. The finished details for such construction can be fully viewed in FIGS. 6, 7, 8, and 15. Co-axial standoffs 25 are used to offset swingarms 7 and 8 relative to rocker arms 6 so that the completed ladder rails are properly spaced for fitment to the rear wheel axle. Two swingarm links 31 and 32 as shown in FIGS. 7 and 15, placed at either side of the shock absorber 9, fasten the rails together using shock absorber common pin 34 and respective bushing 21 and snap-ring 37. Swingarm links 31 and 32 provide a means of force transmission from the rails to the shock absorber 9 through the common pin 34, coaxially held and fastened by said swingarm links 31 and 32. Force transmission generated by riding travels from common pin 34 through to the shock absorber 9, where it is attenuated by some preset amount, to the tail block shock pin 29. The ladder pivots about a swingarm bearing assembly mounted to a first attachment point 54 on the aft section of the central load bearing assembly. A master pivot pin 28 running through hole 54 in plate frames 1 and 2, and through swingarm bearings 22 and 33, hold the two assemblies together by clipping to snap ring 42. Such arrangement permits the swingarm ladder assembly to operate in a riding configuration or be detached for storage purposes. In riding configuration, the assembly is pinned to said hole 54 in both plate frame elements as illustrated in FIG. 11. Riding forces are resolved as a force-moment couple that are jointly resisted at master pivot pin 28, common pin 34 and tail block shock pin 29. Master pivot pin 28 provides a rotational degree of freedom for the swingarm ladder assembly, and captures moment couples generated by loads imposed during riding. Common pin 34, shock absorber 9, and tail block shock pin 29 react against the imposed force of the force-moment couple carried in the swingarm rails. Other elements in FIG. 7, notably bearing elements 20, 22, and 33, are used as low friction loading surfaces for smooth and efficient assembly movement. Removing master pivot pin 28 and rotating the swingarm to a second attachment point at hole 47 in FIG. 11, with subsequent re-insertion of said master pivot pin 28 into hole 47, locks the assembly in stowed configuration. This can be seen clearly in FIG. 15 whereby master pivot pin 28 and snap ring 38 have been relocated to hole 47 for securing the swingarm ladder assembly in folded position. FIGS. 10, 12 and 16 provide additional views of the folded configuration in this aspect of the invention. Swingarms 7 and 8, as well as rocker arms 6, are made from aluminum plate ¼″ thick preferred for the illustrated embodiment. However, an assortment of viable metals and composites of various thicknesses are industrially available, and can be used as alternative construction materials. Also, a variety of load bearing fasteners or viable adhesives can be used in place of the threaded fasteners 18 shown in FIG. 7. The swingarm ladder assembly can be constructed from a plurality of components, as shown in FIG. 7, or from a single piece of formed material as is obvious to one skilled in the art. If formed from a single piece of material, as shown in FIG. 22, it can be appreciated that the unitary swingarm assembly 60 would be configured to incorporate the various offsets 62, 64 allowing for proper attachment of the swingarm assembly to the respective central load bearing assembly at fastening point 66 and the rear wheel axle at receiving channel 68. Other swingarm assemblies commonly available use a number of pivoting linkages to achieve the same function as performed by this embodiment of the invention. Such assemblies are often referred to as 2, 3, or 4 bar linkages. The swingarm assembly shown in the preferred embodiment uses one functional pivoting bar linkage composed of a plurality of components that can be arranged in a variety of ways, especially in respect to placement of shock absorber 9, master pivot pin 28, tail block shock pin 29, and shock absorber common pin 34. In this regard, functionality of the swingarm can be modified for performance requirements by geometric variation but such modification is essentially unchanged from the device illustrated in the attached figures.

A method for constructing a foldable bicycle frame made from opposed planar structural elements having suitable geometry for such function is provided. Such plateframe arrangement, held together at a plurality of co-axial fastener locations, mounts components as required for operation of a high performance, full suspension bicycle having the ability to fold up in a package of compact size. Said fasteners pass through aligned drill holes in both plate frame elements, one or both said plate frame elements having thread forms for fastener threaded engagement as is required for frame securement. This arrangement gives a plateframe structure of modular, lightweight, and weldless construction that can be assembled or disassembled with basic and readily available tools. Although two plate frame elements are prescribed in the embodiment, a practitioner skilled in the art can arrange such system with any number of said plate frame elements as is practicable.

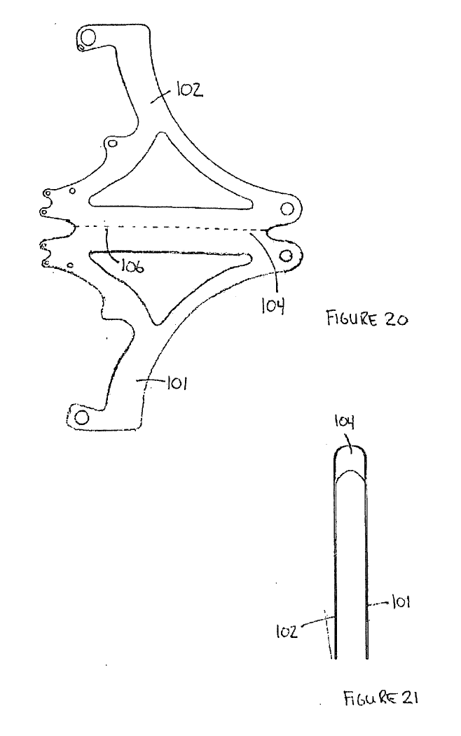

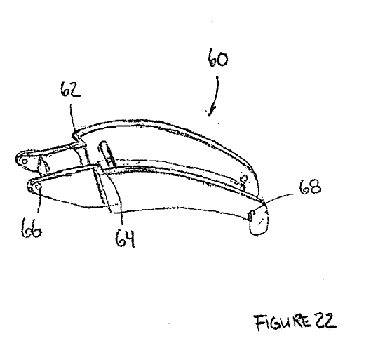

For example, in an alternate embodiment, as shown in FIG. 19, the two spaced-apart plate frame elements 101, 102 are interconnected by a spine 104, the spine being formed by folding a plate having formed therein the appropriately formed opposed frame element patterns for each side of the central load bearing assembly. The folded structure is spaced apart to permit the location and mounting of operative elements in positions required for bike function. The interconnected structure of frame elements 101, 102 is cut from plate stock so as to produce the opposed frame element patterns in an unfolded structure as shown in FIG. 20. The structure is then folded along dashed-line 106, to produce the spine shown more clearly in FIG. 21. To maintain the opposed frame elements 101, 102 in fixed spaced-apart relationship, a series of fasteners, in combination with co-axial standoffs, are used at a number of locations.

The resulting folded frame provides the same mounting points and operational latitude for the mounted operational elements as that described for the embodiment shown, for example, in FIG. 1. The folded frame provides hole 150 on opposed frame elements 101, 102 to capture pivot boss 46 on each side of the pivoting headset (See FIG. 13). Similarly, the folded frame is configured with appropriate fastening points 108 to permit attachment of a tail block for mounting a seat assembly. To support a crank assembly, a lower bracket aperture 110 is provided on opposed frame elements 101, 102, and for mounting a rear wheel, an optional suspension and other associated operational elements, a swingarm assembly is mountable at hole 154. With respect to each of the mounted operational elements, the means and options for fastening the particular element to the frame is as described above for the embodiment shown, for example, in FIG. 1.

The spine 104 of the folded frame shown in FIG. 19 provides an integral structure having opposed frame elements without the need for welding, making the overall structure more durable and failsafe under rigorous riding conditions. In a bicycle frame, the bending moments exerted upon the overall structure from the four primary attachment points (heatset, tail block, swingarm assembly and lower bracket) translate into complex stresses (i.e. torsion, compression, tension) over the entire frame structure. The spine 104 provides additional structural stability between the opposed frame elements 101, 102, thus reducing these various stresses upon the frame. In particular, the generally triangular configuration shown in FIG. 19 provides considerable additional support to the region supporting the pivoting headset and tail block. In situations where the tail block supports a shock absorber, as shown in FIG. 1, the spine 104 provides additional support to the suspension system.

The spine shown in FIGS. 19 through 21 is positioned between the region receiving the pivoting headset and the tail block. It can be appreciated that a practitioner in the art may choose to position the arced spine in an alternate position to provide support to other regions of the frame. For example, the spine could be positioned to span from the lower bracket to the tail block, thus providing additional support to the lower and rear portions of the frame.

In any of the embodiments presented above, mounted to the forward plateframe area is a pivoting headset, with provision for rigidly fixing to and rotating within the twin plate frame structure as required. One position gives a riding operational configuration, the other a folded stowed configuration. Said pivoting headset mounts a rotatable front fork assembly extending therefrom. The front fork rotates within the pivoting headset freely as is required for bike steering function. A mechanically simple, lightweight rear shock absorbing system is integrated into the plateframe design. This shock absorbing system comprises a swingarm assembly, which is pivotally attached to the central load bearing assembly and shock absorber at pinned connection points. Coaxial holes at the rear of the plateframe structure mount a pivot pin that rotatably fastens the swingarm assembly to both plateframe elements, although attachment to a single plateframe is possible as a designer might opt for. A tail block is provided for capturing the top end of the shock absorber and transmitting mechanical loads generated while riding into the plateframe structure. As can be appreciated, the tail block also adjustably mounts a seat post, which may be altered by the rider for best seat position. The plateframe design also routes cables in an internal arrangement, separating them from rider or other attached components or accessories on the inboard side of the plateframe structure. A series of cable mounts mounted within the plate frames are held by frame fasteners and serve to constrain the cables. Overall geometry and dimensions of this configuration may be altered to provide a universal fit for riders of various sizes. In contrast to bicycles of traditional tubular design, the plate structure may be arranged in a variety of ways, giving new appearances and ornamental details not possible before. Furthermore, the plateframe structure makes possible a number of attachment points for additional accessories that could not otherwise be fixed conveniently to a bicycle of traditional tubular design. Said plateframe structures can also be arranged to form functional versions that are lighter, stronger and less costly than other comparable machines in the market.

The above method of construction using plateframe structures offers design flexibility for creating variants of lighter and stronger structure than tubular frame bicycles. In addition, the structural plates forming this new configuration make use of automatic manufacturing techniques that reduce cost and manufacturing time, and increase versatility in relation to standard tubular frame bicycles. Examples of technologies that can be used to prepare the patterns from plate stock include water jet cutting tables, CNC milling machines, flame cutting, industrial scroll saws and lasers. In the embodiment where the two plate frame elements are integral, a blank having the two opposed frame elements interconnected by a web is prepared. The blank is then folded along the web to provide spaced-apart opposed frame elements interconnected by an integral spine formed by the web. Optionally, the blank can be stamped prior to folding to form additional offsets of mounting points or other ornamental or functional purposes.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A bicycle frame comprising:
a central load bearing assembly comprising two spaced-apart frame elements maintained in spaced-apart relationship by a plurality of spacers;
a swingarm assembly having first and second ends, said first end being pivotably mounted on said central load bearing assembly at a first attachment point, said second end of said swingarm assembly having a rear wheel releasably secured thereon;
a headset mounted on said central load bearing assembly for supporting a steering and front fork assembly, said front fork assembly having a front wheel releasably mounted thereon; and
a crank bracket mounted between said two spaced-apart frame elements of said central load bearing assembly, said crank bracket being located offset from said first attachment point of said swingarm assembly, said crank bracket supporting a crank assembly, wherein the two spaced-apart frame elements are interconnected by a spine.

2. The frame according to claim 1, the spine is formed by folding a plate having opposed frame element patterns formed therein.

3. (canceled)

4. The frame according to claim 1, wherein one or more additional plates elements are incorporated to provide additional strength to the central load bearing structure.

5. The frame according to claim 1, wherein said headset is pivotable within the plane of said central load bearing assembly to allow said steering and front fork assembly to rotate between an operational position and a compact stowed position, said headset being lockable in either of said operational or stowed positions.

6. The frame according to claim 1, wherein said swingarm assembly is detachable from said first attachment point.

7. The frame according to claim 6, wherein said central load bearing assembly further comprises a second attachment point for attachment of said swingarm assembly in a compact stowed configuration.

8. The frame according to claim 1, wherein said headset is positioned between said frame elements.

9. The frame according to claim 1, further comprising a tail block mounted on said central load bearing assembly, said tail block supporting a seat assembly for a rider.

10. The frame according to claim 9, wherein said tail block is positioned between said frame elements.

11. The frame according to claim 1, wherein said crank bracket is of cylindrical configuration and positioned within corresponding apertures in said frame elements, said crank bracket being removeably retained by at least one circular clip.

12. The frame according to claim 9, wherein said swingarm assembly has a suspension attachment means for attachment of a shock absorber spanning from said swing arm assembly to a suspension attachment means on said tail block or frame elements.

13. The frame according to claim 1, wherein said swingarm assembly is a single unitary structure.

14. The frame according to claim 1, wherein said swingarm assembly is of plate-frame construction comprising a plurality of components arranged to support a rear wheel thereon.

15. The frame according to claim 1, wherein swingarm assembly is detachably and pivotally connected to said frame elements by means of a pin and circular clip received in corresponding bores within said swingarm assembly and said frame elements.

16. The frame according to claim 1, wherein said spacers are held in place by threaded fasteners or weldments.

17. The frame according to claim 1, wherein operational elements added between said flame elements are substantially equal in width to said spacers.

18. The frame according to claim 1, wherein said spacers provide Support for mounting cable routing fixtures.

19. The frame according to claim 1, wherein said frame elements are made from a material selected from the group consisting of metal, fiberglass and composites.

20. The flame according to claim 1, wherein said frame elements are made from aluminum or titanium plate.

21. The frame according to claim 1, wherein said frame elements comprise elongated slots or drill holes to reduce overall weight.

22. The frame according to claim 1, wherein said swingarm assembly further supports gearing and braking mechanisms.

23. The frame according to claim 1, wherein said frame is Y-shaped in side profile.

24. The frame according to claim 1, wherein the two spaced frame elements are generally planar.

25. (canceled)
